(19) United States
(12) Patent Application Publication
(10) Pub. No.: US 2009/0226734 A1
(43) Pub. Date: Sep. 10, 2009

(54) POLYOXYALKYLENE SILOXANE COPOLYMERS WITH ANTISTATIC PROPERTIES AND THEIR APPLICATION TO FIBERGLASS INSULATION AND OTHER SUBSTRATES

(75) Inventors: Eric J. Lind, Naperville, IL (US); Christine S. Fouts, Wadsworth, IL (US)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Petroferm, Inc., Fernandina Beach, FL (US)

(21) Appl. No.: 12/044,714

(22) Filed: Mar. 7, 2008

(51) Int. Cl. B32B 17/10; C08F 299/08

(52) U.S. Cl. 428/429; 526/279

(57) ABSTRACT

Polyoxyalkylene siloxane copolymer compositions and their application as antistatic agents to fiberglass insulation, textile, plastic, fiber optic, and electronics substrates are described. The polyoxyalkylene siloxane copolymer composition is made by the free radical polymerization of a vinyl polyoxyalkylene siloxane monomer with one or more organic unsaturated monomers. The vinyl polyoxyalkylene siloxane monomer has a linear, branched, or cyclic structure that may or may not be crosslinked. Aqueous solutions of the polyoxyalkylene siloxane copolymers provide improved wetting and uniform coverage on substrates. Treatment of fiberglass insulation with the polyoxyalkylene siloxane copolymers of the invention leads to improved antistatic properties and R-values.

### BACKGROUND OF THE INVENTION

This invention describes polyoxyalkylene siloxane copolymer compositions and their application as antistatic agents in fiberglass insulation, textiles, plastics, fiber optics, and electronics applications such as computer screen coatings, CD & DVD coatings, and coatings for electronic circuit boards. A polyoxyalkylene siloxane copolymer composition in accordance with this invention may be made by the free radical polymerization of a vinyl polyoxyalkylene siloxane monomer with other organic unsaturated monomers. The vinyl polyoxyalkylene siloxane monomer has a linear structure but may also have a branched or cyclic structure that may or may not be crosslinked. The resulting polyoxyalkylene siloxane copolymers contain both hydrophilic and hydrophobic groups and are soluble in water. Aqueous solutions of the polyoxyalkylene siloxane copolymers of the invention provide improved wetting and uniform coverage on substrates. Treatment of fiberglass insulation with these polyoxyalkylene siloxane copolymers leads to improved antistatic properties and R-values.

Electrostatic charge is the result of a buildup of charge on the surface of a substrate due to contact with other surfaces. This surface charge (static) can be generated in the manufacturing processes used to make fiberglass insulation, textiles, plastics, fiber optics, electronics and other substrates. A substrate can be conductive or insulative depending on its level of resistance to electrical flow on its surface. Insulative surfaces localize electrostatic charge. Such static charge generally remains in place until the charge is bled off through a ground or discharged. Many substrates such as fiberglass insulation, plastics and textiles generally have poor conductivity and do not conduct or dissipate electrostatic charge well. Antistatic agents can be used to prevent the build-up of electrostatic charge on these substrates or to reduce the static charge. The term “reduce static” means reducing the surface charge on a substrate. These agents reduce isolated surface charge on the substrates by reducing the resistance to surface electrical flow thereby dissipating electrostatic charge. An antistatic agent can be applied as a surface treatment or it can be used internally as in the manufacture of plastics when it is mixed in with the resin mass prior to the forming operation.

Antistatic agents often have other performance advantages in addition to reducing static charge. For example, some may act as a lubricant or as friction reducer, dedusting agent, or as an emulsifier.

Antistatic agents may be applied to a substrate in neat form or mixed with a solvent and applied as a solution or an emulsion. In addition, some emulsions that are otherwise useful as antistatic agents are not stable to freeze/thaw cycles which reduces their usefulness.

Various quaternary compounds such as amido amine quats derived from fatty acids and polyamines, alkyl or dialkyl long chain tertiary amine quats, ethoxylated amine quats and other quaternary ammonium salts have been used as antistatic agents because they have demonstrated their ability to prevent the build-up of the electrostatic charge on substrates. Some of the negative characteristics of such quaternary antistatic agents include skin irritation, negative impact on the environment, yellowing of the substrate and build up of residues in processing equipment which may interfere with normal operation of the equipment.

U.S. Pat. No. 3,560,544 describes triorganosiloxy endblocked polyoxyalkylene siloxane polymer compositions and salts thereof. The specification of the '544 patent indicates that these compositions were found to be particularly effective as surfactants.

U.S. Pat. Nos. 5,120,812 and 5,162,472 describe free radical polymers containing silicone functional groups that are prepared by free radical polymerization of a silicone polymer having a reactive vinyl group with selected monomers. The resulting silicone compounds are all described as having a very specific structure and as being useful as softening, anti-tangle, and conditioning agents for use in personal care, textile and related applications.

The polyoxyalkylene siloxane copolymer compositions of the present invention include not only branched copolymers but also linear and cyclic copolymer structures, and are soluble in water. Surprisingly, aqueous solutions of these copolymers rapidly and uniformly wet substrates including fiberglass insulation, textiles, plastics, fiber optics, and electronics and result in a uniform surface treatment on the substrate. The polyoxyalkylene siloxane copolymer's water solubility is an advantage in applications where improved wetting and uniform coverage of substrates is desired.

The terms “silicone” and “siloxane” are used herein to describe any organosilicone oligomer or polymer that has a linear, branched, or cyclic structure that may or may not be crosslinked and has a distribution of molecular weights. These silicones or siloxanes may be made by co-hydrolysis or equilibration reactions of suitably functionalized organosilicones and silanes where the silicon atoms in the oligomer or polymer are linked together with oxygen. Optionally, some silicon carbon bonds are formed by reaction (substitution or free radical addition) of hydrocarbons such as alkyl, alkenyl, polyoxyethylene, polyoxypropylene and substituted alkenyl polyoxyalkylenes with the suitably functionalized silicon atoms in the silicone oligomer or polymer.

### BRIEF SUMMARY OF THE INVENTION

The compounds used in the practice of the invention are made by free radical polymerization of vinyl polyoxyalkylene siloxanes and other organic unsaturated monomers carried out under conditions known to those skilled in the art of polymerization. Deviation from standard polymerization procedures may lead to products with variable quality and physical property characteristics. Thus, a monomer solution of the vinyl polyoxyalkylene siloxane monomer and organic unsaturated monomers is prepared in aqueous solution. Other chemical additives, such as chelants, surfactants, and polymer modifiers, are added to the monomer mixture to effect the polymerization reaction and obtain the desired polymer product characteristics. The polymerization is initiated with one or more free radical initiators that can include but are not limited to peroxide, persulfate, azo and redox initiators.

The above compounds are easy to apply, can be applied uniformly to the substrate, and are very effective in reducing electrostatic surface charge in fiberglass insulation, textiles, plastics, fiber optics, and electronics. These compounds are particularly effective in reducing electrostatic surface charge by reducing the resistance to surface electrical flow in fiberglass insulation while also enhancing the R value of the fiberglass insulation.

### DETAILED DESCRIPTION OF THE INVENTION

This invention comprises polyoxyalkylene siloxane copolymer compositions and their application as an antistatic agent for fiberglass insulation, textiles, plastics, fiber optics, and electronics. The polyoxyalkylene siloxane copolymer composition is made by the free radical polymerization of a vinyl polyoxyalkylene siloxane with selected polymerizable organic unsaturated monomers. The vinyl polyoxyalkylene siloxane monomer is linear, branched, or cyclic. The resulting vinyl polyoxyalkylene siloxane copolymers contain both hydrophilic and hydrophobic groups and are soluble in water. The polyoxyalkylene siloxane copolymer can be anionic, cationic, zwitterionic or nonionic depending on the organic unsaturated monomers utilized in the polymerization reaction. Aqueous solutions of these polyoxyalkylene siloxane copolymers provide improved wetting and uniform coverage on substrates as well as outstanding antistatic properties. For example, treatment of fiberglass insulation with polyoxyalkylene siloxane copolymers leads to surprisingly improved antistatic properties and R-values.

In accordance with the invention, polyoxyalkylene siloxanes with one or more terminal vinyl groups may be polymerized with vinyl monomers via free radical polymerization to produce aqueous solutions of polyoxyalkylene siloxane copolymers. The vinyl polyoxyalkylene siloxane monomers containing one or more vinyl groups are linear, branched, or cyclic and may or may not be crosslinked. The vinyl polyoxyalkylene siloxane monomers containing one or more vinyl groups are polymerized with organic unsaturated monomers to produce the polyoxyalkylene siloxane copolymers of the invention. Organic unsaturated monomers that may be used include but are not limited to acrylic acid, methacrylic acid, acrylamide, methacrylamide, N-t-butylacrylamide, diallyldimethyl ammonium chloride, acrylonitrile, maleic acid, maleic anhydride, fumaric acid, itaconic acid, crotonic acid, methyl methacrylate, N,N-dimethylaminoethylacrylate, N,N-dimethylaminoethylacrylate methyl chloride quaternary, N,N-diethylaminoethylacrylate, N,N-diethylaminoethylacrylate methyl chloride quaternary, 2-acrylamido-2-methyl-1-propanesulfonic acid and vinyl pyrrolidone, among others. When acidic unsaturated monomers are used in the polymerization reaction, an optional post neutralization step may be used to produce an anionic polymeric product. The alkali metal salts, Na+, K+, Li+, alkaline-earth metal salts, ammonium salts or protonated amine salts of the acidic monomers may also be used in the polymerization reaction.

The vinyl polyoxyalkylene siloxane monomer used in the practice of this invention may be represented as follows:

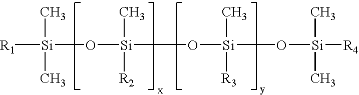

where R₁, R₂, R₃ and R₄ are

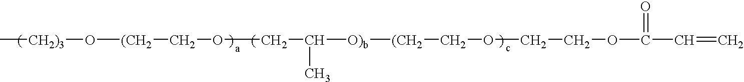

or CH₃ with the exception that all of the R₁, R₂, R₃ and R₄ groups are not CH₃, and
x is an integer from 1-100,
y is an integer from 0-100,
a is an integer from 0-100,
b is an integer from 0-100, and
c is an integer from 0-100.

The above vinyl polyoxyalkylene siloxane monomer is polymerized via free radical polymerization with organic unsaturated monomers as described below.

Organic unsaturated monomer or combination of monomers that are to be used in the practice of the invention include:

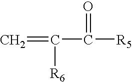

where R₅ is OH, NH₂, or O— M+, where M+ is alkali metal salts, Na+, K+, Li+, alkaline-earth metal salts, ammonium salts or protonated amine salts of the monomer, and R₆ is H or CH₃. Other monomers that can be used include:

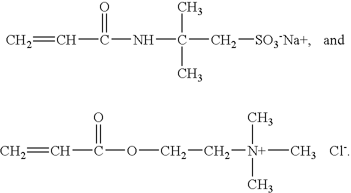

The resulting water soluble polyoxyalkylene siloxane copolymers of the current invention preferably have a viscosity less than 60 centipoise. However, vinyl polyoxyalkylene siloxane monomer polymerized with unsaturated monomers including one or more of the following may have viscosities up to about 250 centipoise:

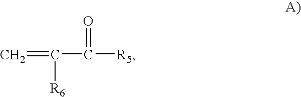

where R₅ is OH or O— M+, where M+ is alkali metal salts, Na+, K+, Li+, alkaline-earth metal salts, ammonium salts or protonated amine salts of the monomer, and R₆ is H or CH₃,

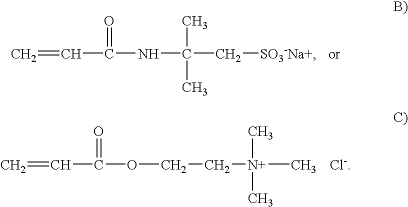

These polyoxyalkylene siloxane copolymers can be applied to fiberglass insulation, textile, plastic, fiber optic, and electronics substrates. Aqueous solutions of the polyoxyalkylene siloxane copolymers of the invention exhibit reduced surface tension and contact angles that improve wetting of the solutions when applied onto substrates such as fiberglass. The aqueous solution of the polyoxyalkylene siloxane copolymer should be applied to fiberglass insulation or the other substrates at a rate sufficient to deliver, on a solids basis, from about 0.01 to about 20 percent by weight, preferably from about 0.01 to about 10 percent by weight and most preferably from about 0.01 to about 5.0 percent by weight of the polyoxyalkylene siloxane copolymer based on substrate weight. This results in uniform coverage of the polyoxyalkylene siloxane copolymer onto the substrate. The resulting substrate surfaces have reduced resistance to surface electrical flow and hence improved anti-static properties, as well as enhanced thermal resistance performance when the substrate is fiberglass insulation.

Although the following examples are presented in order to illustrate the present invention, nothing therein should be taken as limiting the scope thereof.

### EXAMPLES

### Vinyl Polyoxyalkylene Siloxane Monomer

Hydrophilic polyoxyalkylene silicones that may be used are linear, branched or cyclic and have a distribution of molecular weight. Commercially available materials include those from Gelest Inc. (DBE-712, DBE-814, DBE-821, DBP-732, DBP-534); Dow Corning (Dow Corning 193 Fluid, Dow Corning Q2-5211 Superwetter, Dow Corning 5103 Surfactant, Dow Corning Q4-3667 Fluid, Dow Corning Q2-5097 Fluid, Dow Corning 2-8692 Fluid, Dow Corning 1248 Fluid); GESilicones (Silwet L-7230, Silwet L-7600, Silwet L-7604, Silwet L-7607, Silwet L-7644) but are not limited to these commercially available materials. Dow Corning Q4-3667 Fluid was used in the procedures and examples set forth below. This polyoxyalkylene siloxane was reacted in the following examples with acrylic acid in a condensation reaction. The solution was heated to about 140° C. to 180° C., the water stripped off and then the product filtered. The resulting vinyl polyoxyalkylene siloxane (acrylate) was used without further purification.

### General Polymerization Procedure

The general procedure for the free radical polymerization of vinyl polyoxyalkylene siloxanes with other organic unsaturated monomers is as follows. The vinyl polyoxyalkylene siloxane monomer and one or more organic unsaturated monomer(s) are mixed with deionized water in a stirred vessel. The percent solids, based on the total formulation, should be in the range of about 5-50% (water in the range of about 50-95%). Other additives such as chelants, buffers, surfactants, chain transfer agents and solvents that lead to the desired polymer physical properties may be mixed into the monomer or polymer solution. Suitable chelants include but are not limited to ethylenediaminetetraacetic acid (EDTA) disodium salt, sodium triphosphate and/or 1-hydroxy-1,1-diphosphonic acid. Buffers that may be used include conjugate acid-base pairs of carbonic, acetic acid and/or phosphoric acids. Surfactants that may be used include but are not limited to sodium lauryl sulfate, Pluronic L-64, 4-octylphenol polyethoxylate (Triton X-100), polyethylene glycol (LUMULSE PEG 200) and/or polyethylene glycol/polypropylene glycol polymers.

Chain transfer agents that may be used include but are not limited to isopropyl alcohol, bisulfite ion, monobasic sodium phosphate, sodium formate and/or 3-mercaptopropionic acid. The unneutralized acidic monomers may be used in the monomer mixture to produce the nonionic polymer. The acidic monomers may be partially or fully neutralized as desired with caustic or organic amines, then added to the monomer mixture. Optionally, if acidic monomers are polymerized, a post-neutralization with caustic or amines may be used to partially or fully neutralize the polymer. The initial temperatures of the monomer solution can be from about 0° C.-25° C. The resulting monomer solution should be sparged with nitrogen to remove dissolved oxygen. The polymerization may be initiated with free radical initiators which may include but are not limited to peroxide, persulfate, azo or redox initiators. The polymerization reaction is exothermic and therefore cooling should be used to keep the temperature below 90° C. The viscosity of the polymer will increase as the polymerization reaction proceeds. The polyoxyalkylene siloxane polymer product is filtered after the polymerization reaction is completed.

### Example 1

Deionized water (550 g) was added to a vessel equipped with agitation, nitrogen supply, heating and cooling. To this acrylic acid (39.7 g) was added followed by 50% acrylamide (79.4 g) and the Dow Corning Q4-3667 linear polyoxyalkylene siloxane acrylate (26.5 g). This stirred solution was sparged with N₂ at room temperature to remove dissolved oxygen. Ammonium persulfate (7.7 g) and sodium metabisulfite (6.5 g) were added to the stirred monomer mixture. The polymerization reaction was exothermic. The resulting polymer was neutralized with 50% NaOH, then filtered and the product collected. The polyoxyalkylene siloxane copolymer had a viscosity of about 60 cP.

### Example 2

Deionized water (550 g) was added to a vessel equipped with agitation, nitrogen supply, heating and cooling. To this acrylic acid (39.7 g) was added followed by 50% acrylamide (79.4 g) and the Dow Corning Q4-3667 Fluid (26.5 g). This stirred solution was sparged with N₂ at room temperature to remove dissolved oxygen. Ammonium persulfate (10.36 g) and sodium metabisulfite (8.7 g) were added to the stirred monomer mixture. The polymerization reaction was exothermic. The resulting polymer was neutralized with 50% NaOH, then filtered and the product collected. The polyoxyalkylene siloxane copolymer had a viscosity of about 45 cP.

### Example 3

Deionized water (75 parts) was added to a vessel equipped with agitation, nitrogen supply, heating and cooling. To this acrylic acid (5.3 parts) was added followed by 50% acrylamide (5.3 parts) and the Dow Corning Q4-3667 Fluid (3.5 parts). This stirred solution was sparged with N₂ at room temperature to remove dissolved oxygen. Ammonium persulfate (1 parts) and sodium metabisulfite (0.9 parts) were added to the stirred monomer mixture. The polymerization reaction was exothermic. The resulting polymer was neutralized with 50% NaOH, then filtered and the product collected. The polyoxyalkylene siloxane copolymer had a viscosity of about 38 cP.

### Example 4

Deionized water (550 g) was added to a vessel equipped with agitation, nitrogen supply, heating and cooling. To this acrylic acid (39.7 g) was added followed by 50% acrylamide (79.4 g) and the Dow Corning Q4-3667 Fluid (26.5 g). This stirred solution was sparged with N₂ at room temperature to remove dissolved oxygen. Ammonium persulfate (15.5 g) and sodium metabisulfite (13.0 g) were added to the stirred monomer mixture. The polymerization reaction was exothermic. The resulting polymer was neutralized with 50% NaOH, then filtered and the product collected. The polyoxyalkylene siloxane copolymer had a viscosity of about 35 cP.

### Example 5

Deionized water (550 g) was added to a vessel equipped with agitation, nitrogen supply, heating and cooling. To this acrylic acid (39.7 g) was added followed by 50% NaAMPS (79.4 g) and the Dow Corning Q4-3667 Fluid (26.5 g). This stirred solution was sparged with N₂ at room temperature to remove dissolved oxygen. Ammonium persulfate (5.2 g) and sodium metabisulfite (4.4 g) were added to the stirred monomer mixture. The polymerization reaction was exothermic. The resulting polymer was neutralized with 50% NaOH, then filtered and the product collected. The polyoxyalkylene siloxane copolymer had a viscosity of about 120 cP.

### Example 6

Deionized water (550 g) was added to a vessel equipped with agitation, nitrogen supply, heating and cooling. To this acrylic acid (39.7 g) was added followed by 50% NaAMPS (79.4 g) and the Dow Corning Q4-3667 Fluid (26.5 g). This stirred solution was sparged with N₂ at room temperature to remove dissolved oxygen. Ammonium persulfate (5.2 g) and sodium metabisulfite (4.4 g) were added to the stirred monomer mixture. The polymerization reaction was exothermic. The resulting polymer was neutralized with 50% NaOH, then filtered and the product collected. The polyoxyalkylene siloxane copolymer had a viscosity of about 100 cP.

### Example 7

Deionized water (550 g) was added to a vessel equipped with agitation, nitrogen supply, heating and cooling. To this acrylic acid (39.7 g) was added followed by 50% NaAMPS (79.4 g) and the Dow Corning Q4-3667 Fluid (26.5 g). This stirred solution was sparged with N₂ at room temperature to remove dissolved oxygen. Ammonium persulfate (5.2 g) and sodium metabisulfite (4.4 g) were added to the stirred monomer mixture. The polymerization reaction was exothermic. The resulting polymer was neutralized with triethanolamine, then filtered and the product collected. The polyoxyalkylene siloxane copolymer had a viscosity of about 100 cP.

### Example 8

Deionized water (550 g) was added to a vessel equipped with agitation, nitrogen supply, heating and cooling. To this acrylic acid (39.7 g) was added followed by 50% NaAMPS (79.4 g) and the Dow Corning Q4-3667 Fluid (26.5 g). This stirred solution was sparged with N₂ at room temperature to remove dissolved oxygen. Ammonium persulfate (5.2 g) and sodium metabisulfite (4.4 g) were added to the stirred monomer mixture. The polymerization reaction was exothermic. The resulting polymer was neutralized with 2-amino-2-methyl-1-propanol (95%), then filtered and the product collected. The polyoxyalkylene siloxane copolymer had a viscosity of about 100 cP.

### Example 9

Deionized water (550 g) was added to a vessel equipped with agitation, nitrogen supply, heating and cooling. To this acrylic acid (39.7 g) was added followed by 80% N,N-Dimethylaminoethyl acrylate methyl chloride quaternary (49.6 g) and the Dow Corning Q4-3667 Fluid (26.5 g). This stirred solution was sparged with N₂ at room temperature to remove dissolved oxygen. Ammonium persulfate (5.2 g) and sodium metabisulfite (4.4 g) were added to the stirred monomer mixture. The polymerization reaction was exothermic. The resulting polymer was filtered and the product collected.

### Example 10

Surface treatment of a fibrous substrate with the polyoxyalkylene siloxane copolymer is described in this example. A sample of commercially produced virgin fiberglass fibers may be sprayed with an aqueous solution of polyoxyalkylene siloxane copolymer (the copolymer was prepared as described above). The wt % of the polyoxyalkylene siloxane copolymer surface treatment, based on the fiberglass weight, applied to the fiberglass should range from about 0.01-20 wt %. The polyoxyalkylene siloxane copolymer was at a level ranging from 0.01-50% by weight in water. The fiberglass should be treated with the polyoxyalkylene siloxane copolymer in the temperature range of room temperature to 250° C. after which the surface treated fiberglass will be collected and tested. The resulting fiberglass can be treated with additional surface treatments, such as dedusting aids, to aid in the processing of the fiberglass and to impart specific desired properties to the fiberglass product.

Polyoxyalkylene siloxane copolymer aqueous solutions prepared as described above exhibited reduced surface tensions and contact angles in comparison to water (TABLE 1). This improved the wetting of the solutions onto the fiberglass fibers and resulted in a uniform surface treatment.

TABLE 1

| | | Contact Angle |
|---|---|---|
| | Surface Tension | (fluid on virgin |
| Sample | (dynes/cm) | fiberglass) |
| H₂O | 72.5 | 88.7° |
| 1 wt % Polyoxyalkylene siloxane | 42.5 | 65.9° |
| copolymer solution (Ex. 3) | | |

### Example 11

Anti-static properties of a treatment here refer to the ability of the surface treated substrate in question to dissipate electrostatic charge. The reported resistance data in turn is a useful measure of the ability of the fiberglass to dissipate static charge. Thus, surface resistance and static decay tests were used to provide quantitative data indicative of the degree to which the surface-treated substrate dissipated electrostatic charge. Before the samples were tested they were conditioned at 15% humidity and room temperature.

The procedure for measurement of the resistance indicative of electrostatic charge was as follows. The surface treated fiberglass was placed between a conductive metal electrode and a ground plate. A voltage was applied and the resistance was measured. The results are reported in TABLE 2.

The static decay test was used to determine the time (decay time) to dissipate a voltage that was applied to surface treated fiberglass samples. The static decay time for the fiberglass sample was measured using the following procedure: A 5K voltage was applied to the surface treated fiberglass sample for 1 minute. Then the electrodes were grounded, and the time for the voltage on the fiberglass to bleed down to the 10% cutoff level of 500 volts was measured.

Thermal resistance (R value) of the surface treated fiberglass was determined using ASTM Heat Flow Meter Method #C518. The test was performed on 1-inch thick fiberglass insulation samples at room temperature with a 50° F. temperature differential between plates. The thermal resistance (R value) of the fiberglass insulation is dependent on the thickness of the sample among other variables.

As summarized below, the fiberglass insulation that was surface treated with the polyoxyalkylene siloxane copolymers showed markedly improved surface resistance (at an applied voltage), static decay (5K volts) as well as improved thermal resistance (R values) vs. a commercial sample (see TABLE 2).

TABLE 2

| | Surface | Static | Thermal |
|---|---|---|---|
| | Resistance | Decay | Resistance |
| Sample | (Ohms) | (seconds) | (hr-° F.-ft²/BTU) |
| Commercial surface | 2 × 10¹³ | 13 | 3.5 |
| treated fiberglass | | | |
| Fiberglass treated with 1 wt % | 8 × 10⁹ | 3 | 3.9 |
| polyoxyalkylene | | | |
| siloxane copolymer Ex. | | | |
| 3, (based on fiberglass wt) | | | |

What is claimed is:

1. A method for reducing static in fiberglass insulation, textile, plastic, fiber optic, and electronics substrates comprising:
applying to the substrate an effective amount of a polyoxyalkylene siloxane copolymer, the polyoxyalkylene siloxane copolymer having linear, branched, or cyclic structures that may or may not be crosslinked,
the polyoxyalkylene siloxane copolymer having a viscosity less than about 60 centipoise and being prepared by free radical polymerization of a vinyl polyoxyalkylene siloxane containing one or more terminal vinyl groups with one or more organic unsaturated monomers, where the vinyl polyoxyalkylene siloxane monomer is 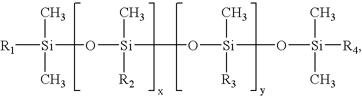
R₁, R₂, R₃ and/or R₄ being 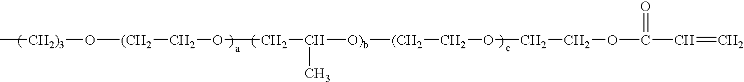
or CH₃ with the exception that R₁, R₂, R₃ and R₄ groups are not CH₃, and
x is an integer from 1-100
y is an integer from 0-100
a is an integer from 0-100
b is an integer from 0-100
c is an integer from 0-100; and
the one or more organic unsaturated monomers are 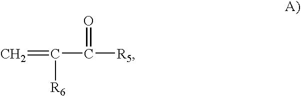
where R₅ is OH, NH₂, or O— M+, where M+ is alkali metal salts, Na+, K+, Li+, alkaline-earth metal salts, ammonium salts or protonated amine salts of the monomer, and R₆ is H or CH₃,

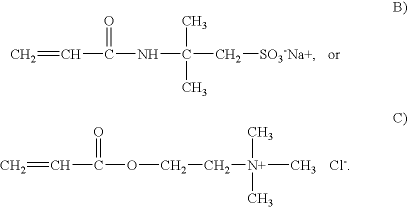

2. The method for reducing static of claim 1 in which the organic unsaturated monomer is: 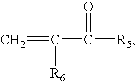
where R₅ is OH, NH₂, or O— M+ where M+ is alkali metal salts, Na+, K+, Li+, alkaline-earth metal salts, ammonium salts or protonated amine salts of the monomer, and R₆ is H or CH₃.

3. The method for reducing static of claim 1 in which the organic unsaturated monomer is:

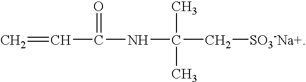

4. The method for reducing static of claim 1 in which the organic unsaturated monomer is:

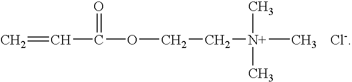

5. The method of claim 1 wherein the polyoxyalkylene siloxane copolymer is applied to the substrate as an aqueous solution at a solids level sufficient to deliver about 0.01 to 20 percent by weight of the polymer based on the weight of the substrate.

6. The method of claim 1 wherein the polyoxyalkylene siloxane copolymer is applied to the substrate as an aqueous solution at a solids level sufficient to deliver about 0.01 to 5.0 percent by weight of the polymer based on the weight of the substrate.

7. A method for reducing static in a fiberglass insulation substrate comprising:
applying to the substrate an effective amount of a polyoxyalkylene siloxane copolymer, the polyoxyalkylene siloxane copolymer having linear, branched, or cyclic structures that may or may not be crosslinked,
the polyoxyalkylene siloxane copolymer having a viscosity less than about 60 centipoise and being prepared by free radical polymerization of a vinyl polyoxyalkylene siloxane containing one or more terminal vinyl groups with one or more organic unsaturated monomers, where the vinyl polyoxyalkylene siloxane monomer is 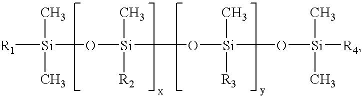
R₁, R₂, R₃ and/or R₄ being 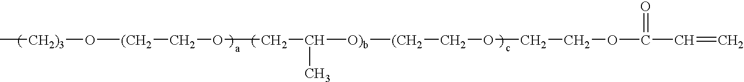
or CH₃ with the exception that R₁, R₂, R₃ and R₄ groups are not CH₃, and
x is an integer from 1-100
y is an integer from 0-100
a is an integer from 0-100
b is an integer from 0-100
c is an integer from 0-100; and
the one or more organic unsaturated monomers are 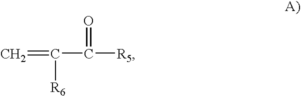
where R₅ is OH, NH₂, or O— M+, where M+ is alkali metal salts, Na+, K+, Li+, alkaline-earth metal salts, ammonium salts or protonated amine salts of the monomer, and R₆ is H or CH₃,

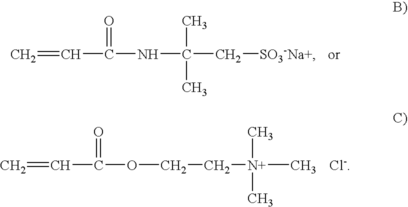

8. The method for reducing static in fiberglass insulation of claim 7 in which the organic unsaturated monomer is: 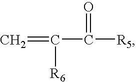
where R₅ is OH, NH₂, or O— M+ where M+ is alkali metal salts, Na+, K+, Li+, alkaline-earth metal salts, ammonium salts or protonated amine salts of the monomer, and R₆ is H or CH₃.

9. The method for reducing static in fiberglass insulation of claim 7 in which the organic unsaturated monomer is:

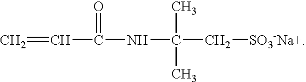

10. The method for reducing static in fiberglass insulation of claim 7 in which the organic unsaturated monomer is:

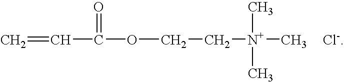

11. The method of claim 7 wherein the polyoxyalkylene siloxane copolymer is applied to the substrate as an aqueous solution at a solids level sufficient to deliver about 0.01 to 20 percent by weight of the polymer based on the weight of the substrate.

12. The method of claim 7 wherein the polyoxyalkylene siloxane copolymer is applied to the substrate as an aqueous solution at a solids level sufficient to deliver about 0.01 to 5.0 percent by weight of the polymer based on the weight of the substrate.

13. A static-reduced fiberglass substrate comprising:
fiberglass insulation surface-treated with an effective amount of a polyoxyalkylene siloxane copolymer having a viscosity less than about 60 centipoise prepared by free radical polymerization of a vinyl polyoxyalkylene siloxane containing one or more terminal vinyl groups with one or more organic unsaturated monomers, where the vinyl polyoxyalkylene siloxane monomer is 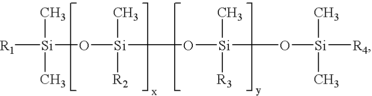
R₁, R₂, R₃ and/or R₄ being 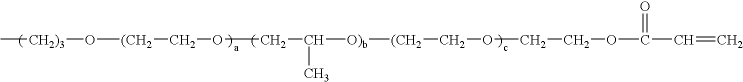
or CH₃ with the exception that R₁, R₂, R₃ and R₄ groups are not CH₃, and
x is an integer from 1-100
y is an integer from 0-100
a is an integer from 0-100
b is an integer from 0-100
c is an integer from 0-100; and
the one or more organic unsaturated monomers are 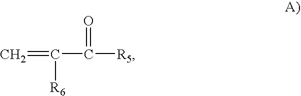
where R₅ is OH, NH₂, or O— M+, where M+ is alkali metal salts, Na+, K+, Li+, alkaline-earth metal salts, ammonium salts or protonated amine salts of the monomer, and R₆ is H or CH₃,

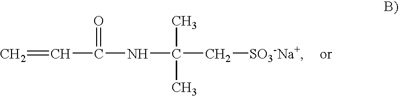

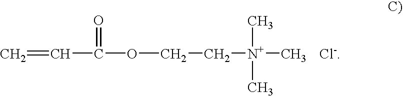

14. The static-reduced fiberglass substrate of claim 13 in which the organic unsaturated monomer is: 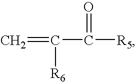
where R₅ is OH, NH₂, or O— M+ where M+ is alkali metal salts, Na+, K+, Li+, alkaline-earth metal salts, ammonium salts or protonated amine salts of the monomer, and R₆ is H or CH₃.

15. The static reduced fiberglass substrate of claim 13 in which the organic unsaturated monomer is:

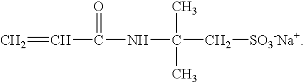

16. The static reduced fiberglass substrate of claim 13 in which the organic unsaturated monomer is:

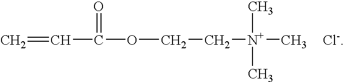

17. The static-reduced fiberglass substrate of claim 13 wherein the fiberglass substrate is surface treated with about 0.01 to 20 percent by weight of the polyoxyalkylene siloxane copolymer based on the weight of the substrate.

18. The static-reduced fiberglass substrate wherein the fiberglass substrate is surface treated with about 0.01 to 5.0 percent by weight of the polyoxyalkylene siloxane copolymers based on the weight of the substrate.

19. A polyoxyalkylene siloxane copolymer having linear or cyclic structures that may or may not be crosslinked,
the polyoxyalkylene siloxane copolymer having a viscosity less than about 60 centipoise and being prepared by free radical polymerization of a vinyl polyoxyalkylene siloxane containing one or more terminal vinyl groups with one or more organic unsaturated monomers, where the vinyl polyoxyalkylene siloxane monomer is 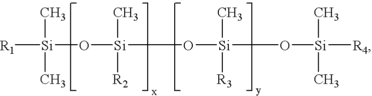
R₁, R₂, R₃ and/or R₄ being 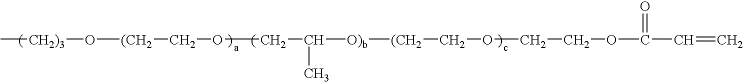
or CH₃ with the exception that R₁, R₂, R₃ and R₄ groups are not CH₃, and
x is an integer from 1-100
y is an integer from 0-100
a is an integer from 0-100
b is an integer from 0-100
c is an integer from 0-100; and
the one or more organic unsaturated monomers are 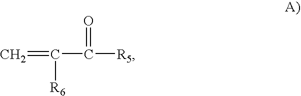
where R₅ is OH, NH₂, or O— M+, where M+ is alkali metal salts, Na+, K+, Li+, alkaline-earth metal salts, ammonium salts or protonated amine salts of the monomer, and R₆ is H or CH₃,

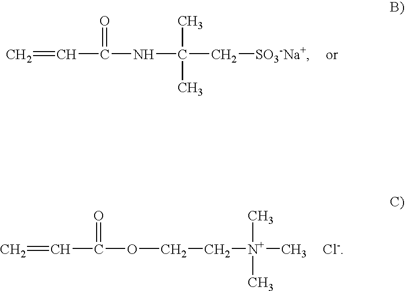

20. A method for reducing static in fiberglass insulation, textile, plastic, fiber optic, and electronics substrates comprising:
applying to the substrate an effective amount of a polyoxyalkylene siloxane copolymer, the polyoxyalkylene siloxane copolymer having linear, branched, or cyclic structures that may or may not be crosslinked,
the polyoxyalkylene siloxane copolymer having a viscosity less than about 250 centipoise and being prepared by free radical polymerization of a vinyl polyoxyalkylene siloxane containing one or more terminal vinyl groups with one or more organic unsaturated monomers, where the vinyl polyoxyalkylene siloxane monomer is 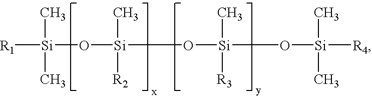
R₁, R₂, R₃ and/or R₄ being 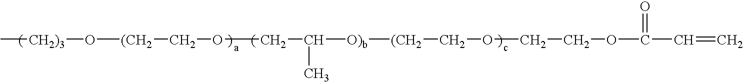
or CH₃ with the exception that R₁, R₂, R₃ and R₄ groups are not CH₃, and
x is an integer from 1-100
y is an integer from 0-100
a is an integer from 0-100
b is an integer from 0-100
c is an integer from 0-100; and
the one or more organic unsaturated monomers are 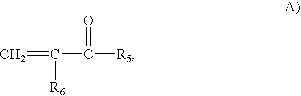
where R₅ is OH or O— M+, where M+ is alkali metal salts, Na+, K+, Li+, alkaline-earth metal salts, ammonium salts or protonated amine salts of the monomer, and R₆ is H or CH₃, [chemical structure]
